(19) United States
(12) Patent Application Publication
(10) Pub. No.: US 2023/0030137 A1
(43) Pub. Date: Feb. 2, 2023

(54) ORGANIZATIONAL APPARATUS WITH EXPANDING FOAM

(71) Applicant: Welli Bins Co., Hamilton, MA (US)

(72) Inventors: Kathleen McIntyre, Hamilton, MA (US); Andrew McIntyre, Brooklyn, NY (US)

(73) Assignee: Welli Bins Co., Hamilton, MA (US)

(21) Appl. No.: 17/815,260

(22) Filed: Jul. 27, 2022

Related U.S. Application Data
(60) Provisional application No. 63/203,589, filed on Jul. 27, 2021.

(51) Int. Cl. B65D 1/22; B65D 25/30; B29B 7/90; B29C 44/02; B29C 44/34

(52) U.S. Cl. CPC B65D 1/22; B65D 25/30; B29B 7/90; B29C 44/02; B29C 44/3415; B29K 2023/083

(57) ABSTRACT

A design, material, and process of manufacturing an organizational apparatus, e.g., an organizational bin, made from expanding-foam. In some examples, the bin includes four walls and a base forming an interior cavity that is configured to receive items to be organized, stored, or transported, e.g., shoes, or dirty or wet items. In some examples, the material used is a plant-based or bio-based Ethylene-vinyl Acetate (EVA) expansion-foam.

### CROSS-REFERENCE TO RELATED APPLICATIONS

This application claims priority to U.S. Provisional Patent Application Ser. No. 63/203,589, filed on Jul. 27, 2021, and entitled “ORGANIZATIONAL APPARATUS WITH EXPANDING FOAM,” which application is herein incorporated by reference in its entirety.

### BACKGROUND

Aspects and implementations of the present disclosure are generally directed to apparatuses made with expanding foam and methods of manufacturing apparatuses with expanding foam, more specifically to organizational apparatuses made with plant-based expanding foam.

The market for organization products, e.g., bins, baskets, totes, etc., lack options that that are durably made for years of use, lightweight, easily washed, and manufactured with sustainable materials and processes. Consumers seek products that have a quality design with durable and sustainable materials in an effort to extend the longevity of those products and curb the throwaway plastic culture that is damaging our planet. These same consumers are interested in products that are made from sustainable materials in an effort to support products that help to reduce carbon-dioxide emissions.

Current market options include injection molded plastic bins, woven baskets, and cut and sewn fabric bins. Molded plastic bins have a cheap-looking aesthetic and do not consider the environment in their design as they are produced through injection molding virgin plastic. Woven baskets are not durable and users often throw them out after they become used or dirty. Woven baskets are also expensive, take excessive human labor to assemble, and are made with cheap labor because of this. Woven baskets are also very difficult to clean thoroughly and deteriorate when damp or wet. Fabric bins are often lined internally with plastic sheets—giving them the necessary structure and stiffness—but this process makes cleaning the fabric tedious and the products are not durable because they rely on laminating plastic to fabric with glue. Fabric bins that do not have internal structural parts (e.g., bins made of felt) are flimsy and do not have the structure to withstand daily use. Felt is also a non-woven material that is difficult to clean because of its loose fibers.

### SUMMARY OF THE DISCLOSURE

The present disclosure provides a new design, material, and process of manufacturing an organizational apparatus, e.g., an organizational bin, made from expanding-foam. In some examples the expanding-foam is a plant-based Ethylene-vinyl Acetate (EVA) foam. In some examples, the bin includes four walls and a base forming an interior cavity that is configured to receive items to be organized, stored, or transported, e.g., shoes, or dirty or wet items. The organizational bin is made through a minimal-waste process, where the entire product is formed in a single injection-molding step. The raw bio-based materials used in the process are mixed in the desired formulation, the bin is molded in a crosslinking expansion process, and finally the bin is cooled on a shaping jig, which helps to set its final shape and dimensions. The EVA expansion-foam process creates a bin that is sealed on all its surfaces to protect the foam from the environment. This feature makes it washable, durable, and improves its resistance to tearing. The mass of the raw foam material is carefully controlled during molding to minimize any waste. Any excess EVA foam that is not crosslinked can be recycled. Additionally, the expansion-foam process allows for the manufacture of bins in a wide range of colors and texture finishes, and allows logos and branding information to be directly molded into the surface of the bin without additional manufacturing steps.

In one example, an organizational bin made of expansion-foam material is provided, the organizational bin including a base and a plurality of walls, wherein each of the plurality of walls includes a first end and a second end, wherein each of the first ends of the walls are integrally formed with the base, thereby forming a cavity between the plurality of walls; and wherein the base and the plurality of walls comprise the expansion-foam material.

In one aspect, the expansion-foam material is bio-based Ethylene-vinyl Acetate (EVA) expansion-foam made from sugarcane.

In one aspect, the base includes an inside surface in communication with the cavity, and an outside surface, the base further including a ledge at a boundary between outside surface of the base and each of the plurality of walls.

In one aspect, the plurality of walls includes at least four walls such that the cavity substantially forms a cube.

In one aspect, the base includes an inside surface in communication with the cavity, and an outside surface, the base further including a ledge at the boundary between the outside surface of the base and each of the four walls, such that the ledge is arranged to contact a surface beneath the organizational bin and a recess of the outside surface of the base is not in contact with the surface beneath the organization bin.

In an aspect, the expansion-foam material comprises from about 65% to about 70% bio-based ethylene-vinyl acetate resin material.

In an aspect, the expansion-foam material comprises from about 2% to about 8% natural cellulose fiber.

In an aspect, the expansion-foam material comprises from about 15% to about 20% polyethylene.

In an aspect, the expansion-foam material comprises from about 1% to about 3% zinc oxide.

In an aspect, the expansion-foam material comprises from about 1% to about 5% of a pigment.

In an aspect, the expansion-foam material has a density of about 0.3 g/cm³.

In an aspect, the expansion-foam material has a durometer reading of between 65 and 75 using an Asker-C durometer.

In another example, a process of manufacturing an organizational bin is provided. The method comprises: providing a raw bio-based ethylene-vinyl acetate expansion-foam from sugar cane in a carbon-negative process; mixing the bio-based ethylene-vinyl acetate expansion-foam with at least one of cellulose fibers, polyethylene, assorted pigments, a coupling agent, a blowing agent, and a crosslinking agent to form an ethylene-vinyl acetate expansion-foam material; molding the ethylene-vinyl acetate expansion-foam material to form an organizational bin component; pre-cooling the organizational bin component for a period of time; placing the organizational bin on a shaping jig to form an organizational bin; and finishing the cooling process.

In an aspect, the period of time is about 30 seconds.

In an aspect, the ethylene-vinyl acetate expansion-foam material comprises from about 65% to about 70% bio-based ethylene-vinyl acetate resin material.

In an aspect, the ethylene-vinyl acetate expansion-foam material comprises from about 2% to about 8% natural cellulose fiber.

In an aspect, the ethylene-vinyl acetate expansion-foam material comprises from about 15% to about 20% polyethylene.

In an aspect, the ethylene-vinyl acetate expansion-foam material comprises from about 1% to about 3% zinc oxide.

In an aspect, the ethylene-vinyl acetate expansion-foam material comprises from about 1% to about 5% of a pigment.

In an aspect, the ethylene-vinyl acetate expansion-foam material has a density of about 0.3 g/cm³ and has a durometer reading of between 65 and 75 using an Asker-C durometer.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a perspective view of an organizational bin according to the present disclosure.

FIG. 2A is a front elevation view of an organizational bin according to the present disclosure.

FIG. 2B is a rear elevation view an organizational bin according to the present disclosure.

FIG. 3A is a left side elevation view an organizational bin according to the present disclosure.

FIG. 3B is a right side elevation view of an organizational bin according to the present disclosure.

FIG. 4A is a top plan view an organizational bin according to the present disclosure.

FIG. 4B is a bottom plan view of an organizational bin according to the present disclosure.

### DETAILED DESCRIPTION OF EMBODIMENTS

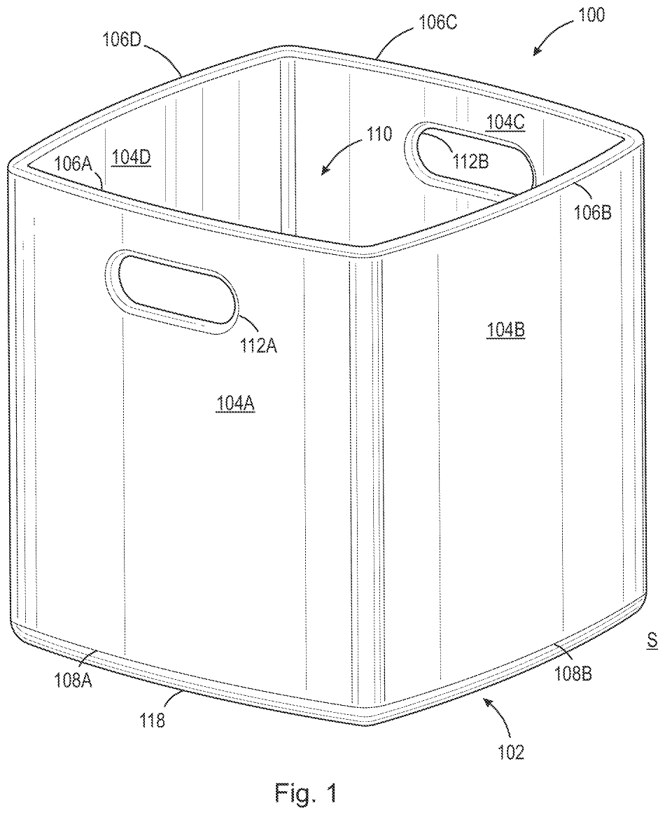

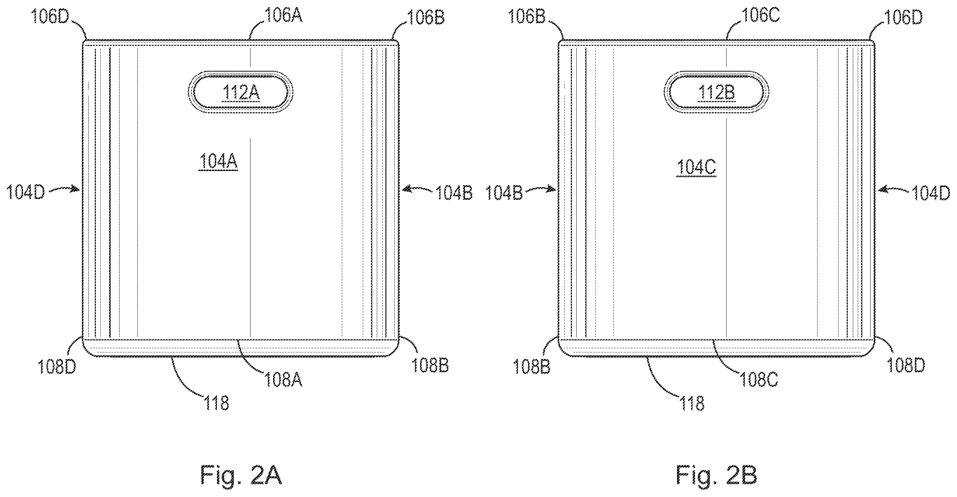

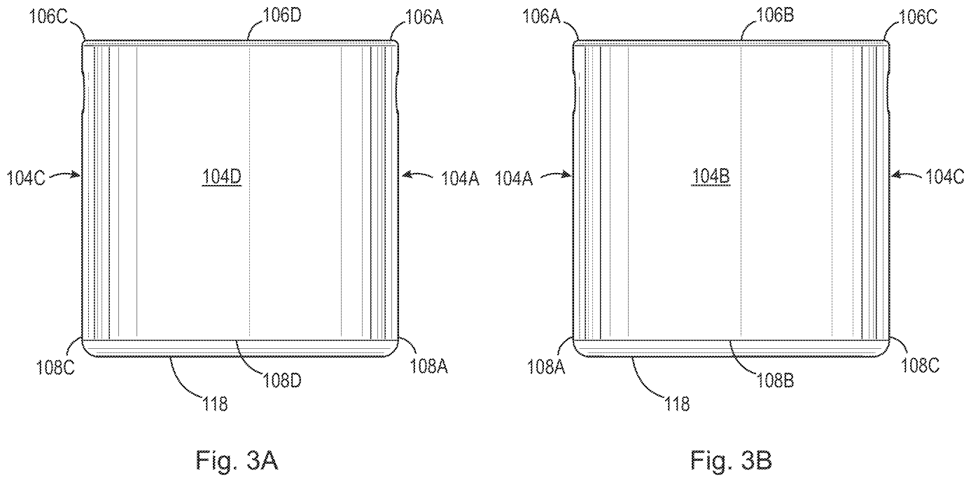

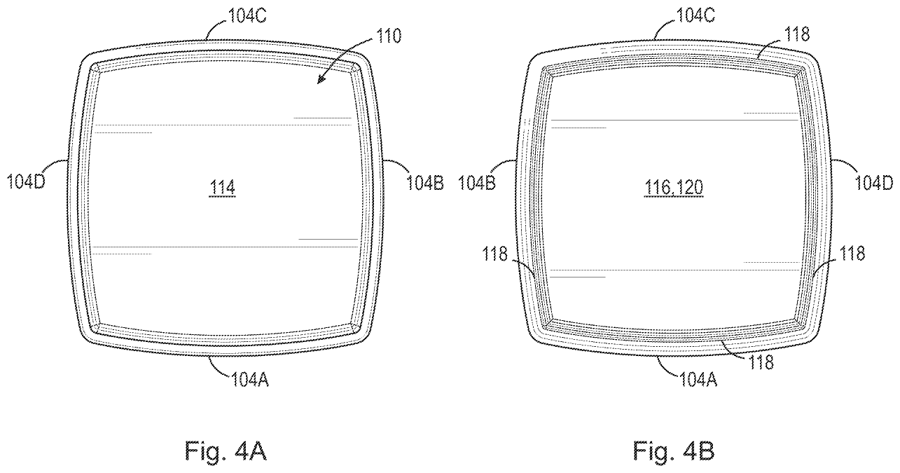

The present disclosure provides a new design, material, and process of manufacturing an organizational apparatus, e.g., an organizational bin, made from expanding-foam. In some examples the expanding-foam is a plant-based Ethylene-vinyl Acetate (EVA) foam. In some examples, the bin includes four walls and a base forming an interior cavity that is configured to receive items to be organized, stored, or transported, e.g., shoes, or dirty or wet items. The following description should be read in view of FIGS. 1-4B. FIG. 1 is a front perspective view of an organization bin 100 according to the present disclosure. FIGS. 2A-2B illustrated front and rear elevational views of organizational bin 100, respectively. FIGS. 3A-3B illustrate left and right side elevational view of organizational bin 100, respectively. FIGS. 4A-4B illustrate top and bottom plan views of organizational bin 100, respectively.

As shown, organizational bin 100 includes a base 102 and a plurality of walls, e.g., walls 104A-104B (collectively referred to herein as “walls 104” or “plurality of walls 104”). Each wall of the plurality of walls 104 includes a first end, e.g., first ends 106A-106D (collectively referred to herein as “first end 106” or “first ends 106”) and a second end, e.g., second ends 108A-108D (collectively referred to herein as “second end 108” or “second ends 108”). The dimension of each wall 104 between first end 106 and second end 108 and along a line that intersects both the first end 106 and second end 108 will be referred to as the length of the wall 104 or the height of the wall 104, while the dimension between the first end 106 and the second end 108 along a line substantially orthogonal to the length of the wall 104 will be referred to as the width of the wall 104. As will be discussed below, in one example embodiment, the organizational bin 100 is intended to be formed using a single injection molding process, and therefore, base 102 and walls 104 can be formed as a single integral body. For example, each second end 108 of the walls 104 can be integrally formed with the base 102 to form a single unitary body.

Additionally, in the example illustrated in FIG. 1, organizational bin 100 can include at least two walls 104, e.g., four walls 104A-104D that are integrally formed with base 102 so as to form the shape of a box with an open top (opposite the base 102). This shape substantially forms an open or negative space within the boundaries created by the walls 104 and base 102, i.e., a cavity 110. As shown cavity 110 is substantially cube shaped and can be configured to hold, transport, or otherwise secure common household items, e.g., shoes, wet clothing, drinks, etc.

As shown in FIGS. 1-2B, organizational bin 100 includes at least two handle apertures 112A-112B. In the examples illustrated, first handle aperture 112A is configured on or within first wall 104A on the front side of organizational bin 100 while second handle aperture 112B is configured on or within third wall 104C on the rear side of the organization bin 100. Although not illustrated it should be appreciated that first aperture handle 112A and second aperture handle 112B can be positioned on or within second wall 104B and fourth wall 104D. Each handle aperture 112A-112B is intended to be a hole, aperture or through-bore through the respective walls 104 and are configured to engage with a user's hand when lifting or transporting organizational bin 100. Although illustrated as circular or elliptical aperture with flattened top and bottom, it should be appreciated that handle apertures 112A-112B can be any shape and size sufficient to engage with a user's hand, e.g., square, rectangular, hexagonal, octagonal. FIGS. 3A-3B illustrated left and right side elevational views of organizational bin 100, including a view of fourth wall 104D and second wall 104B.

As can be seen in FIGS. 3A-3B as well as FIGS. 4A-4B, along the width dimension of walls 104, each wall can include a curve or bow that gives each wall a concave contour. In these examples the cavity 110 is a substantially cubical volume where the outer boundaries of the cavity are also concave. As will be discussed below, the concave contour of the walls aids the manufacturing process in that it makes removal of the organizational bin 100 from a cooling jig easier than flat side walls, and it also provides a pleasing aesthetic shape to organization bin 100.

FIGS. 4A-4B illustrate top plan and bottom plan views of organizational bin 100, respectively. As shown in FIG. 4A, base 102 includes an inside surface 114 configured to receive and support any items placed within cavity 110. Additionally, FIG. 4B illustrates that base 102 also includes an outside surface 116 configured to sit proximate with or in contact with a surface S beneath the organization bin, e.g., the floor, table, desk, etc., that the organization bin 100 is set on when not being transported. As shown in FIG. 4B, where outside surface 116 and second ends 108 of walls 104 meet, i.e., along an outer boundary of outside surface 116, organizational bin 100 includes a ledge 118 configured to make contact with surface S and ensure that organizational bin 100 will stand upright and retain its substantially cube-like shape when not being transported, i.e., when set on surface S. As shown in FIGS. 1-3B, ledge 118 is intended to protrude away from the planar surface of outside surface 116 of base 102 and can have a substantially U-shaped cross-sectional profile along the entire ledge 118. The rounded shape caused by the U-shaped cross-sectional profile adds to the stability and aesthetic appearance of the organizational bin 100. During use of organizational bin 100, the bin is placed on surface S such that a substantial portion or all of ledge 118 contacts surface S. By setting the bin on the ledge 118, a recess 120 (shown in FIG. 4B) is formed beneath organizational bin 100 between the surface S and the outside surface 116 of base 102. Although the portion of base 102 that corresponds with recess 120 can deform during use, the majority of or all of the weight held or supported by organizational bin 100 is supported by ledge 118. Additionally, the formation of ledge 118 includes the addition of material about the perimeter of base 102 where base 102 and walls 104 meet. Therefore, the addition of material in this area increases the structural integrity and rigidity of walls 104 and assist in maintaining the substantially cube-like shape of the organizational bin 100.

As set forth above, base 102 and walls 104 can be formed as a single unitary body. It should be appreciated that base 102 and walls 104 can be made from expanding-foam (also referred to as “expansion-foam”). The material formulation for the expanding-foam used for the present disclosure includes: 65%-70% bio-based EVA resin material; 2%-8% natural cellulose fiber; 15%-20% Polyethylene, 1%-3% Zinc Oxide; and 1%-5% assorted pigments. The material discussed herein and formed using the processes discussed below have an approximate density of 0.3 g/cm³ and have a durometer reading of between 65-75 (unitless) using an Asker-C durometer. In some examples, the bio-based EVA resin material is manufactured from plant-based renewable materials, e.g., sugar cane. The use of sugar cane in this process results in a carbon-negative impact on the environment.

The process of manufacturing the organization bin includes: sourcing the raw bio-based EVA expansion-foam from sugar cane (carbon-negative process); mixing the bio-based EVA expansion-foam with cellulose fibers, polyethylene, assorted pigments, and any necessary coupling agent, blowing agent, and crosslinking agent; molding the bio-based EVA expansion-foam in an EVA expansion-foam molding process to form an organizational bin component; pre-cooling the organizational bin component (e.g., for 30 seconds); turning the organizational bin component upside down and placing it on a shaping jig to form an organizational bin and finishing the cooling process. The step of pre-cooling can include placing the organizational bin component on a table or other cool surface for approximately 30 seconds before moving to the shaping jig. Thus pre-cooling step is utilized to ensure that the organizational bin shrinks evenly on its top edge (i.e., proximate first end 106) and allows for better control of the final cooled flatness of that edge. This process produces an organizational bin that is completely sealed such that the entire exposed surface area is water-proof.

The apparatus and processes outlined herein provide distinct advantages over present offerings. First, the rigid base 102 with ledge 118 keeps the bottom of the organizational bin 100 sitting flat on surface S and increases overall stiffness of the bin. The enhanced stiffness provided by base 102 and ledge 118 also ensures that the bin always returns to its original shape and sits flatly on surface S. Also, the expansion-foam gives a novel aesthetic and feel to a common product that has not been treated in this way before. The foam is stiff enough to keep its shape and strength, yet pliable, so that it protects the items it carries in transit. This material makes it easier to transport. One example use case of the organizer bin is to transport and organize items that regularly move between the house and the car. The flexible construction makes it possible to use the bin in multiple types of settings and use cases, inside and outside the house. Additionally, the use of two handles, i.e., first and second handle apertures 112A-112B that are molded into the walls 104 of the bin, make carrying the bin simple and ergonomic. As mentioned above, the bio-based EVA expansion-foam used is made from sugarcane in a carbon-negative process. By reducing oil-based plastic materials, the processes herein also reduce the production of toxic and harmful pollutants to the environment. The EVA expansion-foam described herein is also nontoxic and resistant to standard household chemicals and UV rays. Furthermore, the process used to mold the expansion-foam allows for the integration of logos or branding directly molded to the surface of the walls 104 or base 102 of the bin without additional manufacturing steps.

As mentioned above, the completely sealed surface makes the bin easy to clean as it is impenetrable to water. Research has shown that current bins on the market are often thrown away when they get dirty because they are very hard to clean. By making the bin easily washable, it encourages users to keep using the bin for a longer product lifetime over traditional bins or baskets.

Furthermore, the bio-based EVA expansion-foam material is a good insulator.

Therefore, the organizational bin 100 described and manufactured using the processes herein can be used to keep items cold or hot depending on need. For example, the expansion-foam will keep ice and/or drinks cold for longer than standard plastic bins. This allows users to use the bin for carrying drinks or food in any setting including outdoor activities, like camping, going to the beach, or going to the pool.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An organizational bin made of an expansion-foam material, comprising:
a base; and
a plurality of walls, wherein each of the plurality of walls includes a first end and a second end, wherein each of the first ends of the walls are integrally formed with the base, thereby forming a cavity between the plurality of walls;
wherein the base and the plurality of walls comprise the expansion-foam material.

2. The organizational bin of claim 1, wherein the expansion-foam material is bio-based ethylene-vinyl acetate (EVA) expansion-foam made from sugarcane.

3. The organizational bin of claim 1, wherein the base includes an inside surface in communication with the cavity, and an outside surface, the base further comprising a ledge at a boundary between outside surface of the base and each of the plurality of walls.

4. The organizational bin of claim 1, wherein the plurality of walls includes at least four walls such that the cavity substantially forms a cube.

5. The organizational bin of claim 4, wherein the base includes an inside surface in communication with the cavity, and an outside surface, the base further comprising a ledge at the boundary between the outside surface of the base and each of the four walls, such that the ledge is arranged to contact a surface beneath the organizational bin and a recess of the outside surface of the base is not in contact with the surface beneath the organization bin.

6. The organizational bin of claim 1, wherein the expansion-foam material comprises from about 65% to about 70% bio-based ethylene-vinyl acetate resin material.

7. The organizational bin of claim 1, wherein the expansion-foam material comprises from about 2% to about 8% natural cellulose fiber.

8. The organizational bin of claim 1, wherein the expansion-foam material comprises from about 15% to about 20% polyethylene.

9. The organizational bin of claim 1, wherein the expansion-foam material comprises from about 1% to about 3% zinc oxide.

10. The organizational bin of claim 1, wherein the expansion-foam material comprises from about 1% to about 5% of a pigment.

11. The organizational bin of claim 1, wherein the expansion-foam material has a density of about 0.3 g/cm³.

12. The organizational bin of claim 1, wherein the expansion-foam material has a durometer reading of between 65 and 75 using an Asker-C durometer.

13. A process of manufacturing an organizational bin, comprising:
providing a raw bio-based ethylene-vinyl acetate expansion-foam from sugar cane in a carbon-negative process;
mixing the bio-based ethylene-vinyl acetate expansion-foam with at least one of cellulose fibers, polyethylene, assorted pigments, a coupling agent, a blowing agent, and a crosslinking agent to form an ethylene-vinyl acetate expansion-foam material;
molding the ethylene-vinyl acetate expansion-foam material to form an organizational bin component;
pre-cooling the organizational bin component for a period of time;
placing the organizational bin on a shaping jig to form an organizational bin; and
finishing the cooling process.

14. The process of claim 13, wherein the period of time is about 30 seconds.

15. The process of claim 13, wherein the ethylene-vinyl acetate expansion-foam material comprises from about 65% to about 70% bio-based ethylene-vinyl acetate resin material.

16. The process of claim 13, wherein the ethylene-vinyl acetate expansion-foam material comprises from about 2% to about 8% natural cellulose fiber.

17. The process of claim 13, wherein the ethylene-vinyl acetate expansion-foam material comprises from about 15% to about 20% polyethylene.

18. The process of claim 13, wherein the ethylene-vinyl acetate expansion-foam material comprises from about 1% to about 3% zinc oxide.

19. The process of claim 13, wherein the ethylene-vinyl acetate expansion-foam material comprises from about 1% to about 5% of a pigment.

20. The process of claim 13, wherein the ethylene-vinyl acetate expansion-foam material has a density of about 0.3 g/cm³ and has a durometer reading of between 65 and 75 using an Asker-C durometer.
